(19) United States
(12) Patent Application Publication
(10) Pub. No.: US 2009/0088198 A1
(43) Pub. Date: Apr. 2, 2009

(54) MESSAGE PROCESSING METHOD, SSMN PROCESSOR AND MESSAGE SERVICE CENTER

(75) Inventor: Weiming Cheng, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/240,496

(22) Filed: Sep. 29, 2008

(30) Foreign Application Priority Data
Sep. 30, 2007 (CN) 200710123677.4

(51) Int. Cl. H04M 1/00

(52) U.S. Cl. 455/551

(57) ABSTRACT

A message processing method, a single SIM multiple numbers (SSMN) processor, and a message service center are described in the embodiments of the present invention. The message processing method includes: receiving a message; determining a sending or receiving terminal of the message as a SSMN terminal; obtaining a virtual number of the SSMN terminal; and processing the message by the virtual number. According to the present invention, multiple numbers of a SSMN subscriber can be online at the same time, so that the subscriber may send and receive messages both through the host and virtual numbers.

### CROSS-REFERENCE TO RELATED APPLICATIONS

This application claims priority to Chinese Patent Application No. 200710123677.4, filed Sep. 30, 2007, entitled “Method Processing Method, SSMN Processor and Message Service Center,” the contents of which are hereby incorporated by reference in its entirety.

### FIELD OF THE INVENTION

The present invention relates to the message service field, and more particularly, to a message processing method, a single SIM multiple numbers (SSMN) processor, and a message service center.

### BACKGROUND

In modern society, with rapid development of mobile communication technologies, it becomes more and more convenient for communication. Due to the expansion of communication scope and the diversification of communication objectives, an increasing number of people start to use several cell-phone numbers for different purposes. However, the application of multiple cell-phone numbers also brings a lot of inconveniences to the subscriber. Therefore, to solve the above problem, technical solutions such as single handset with multiple SIM cards, and single SIM multiple numbers (SSMN) emerge as required.

The solution of single handset with multiple SIM cards means inserting multiple subscriber identity model (SIM) cards in a subscriber terminal, so that the subscriber is free to switch to any SIM card for communication. The solution of SSMN mainly means employing a single SIM card to store the information of multiple cell-phone numbers, so that the subscriber may switch to different cell-phone numbers for communication.

Seen from the above, the solutions of single handset with multiple SIM cards and SSMN have the following major defect.

That is, multiple numbers cannot be online at the same time. Therefore, the subscriber has to select a currently used cell-phone number and the offline numbers are unavailable.

### SUMMARY

Accordingly, the present invention is directed to a message processing method, a single SIM multiple numbers (SSMN) processor and a message service center. Therefore, multiple numbers of a SSMN subscriber can be online at the same time, so that the subscriber may send and receive messages both through the host and virtual numbers.

In order to solve the above technical problem, a message processing method is provided in an embodiment of the present invention. The method includes the following steps.

A message is received.

A sending or receiving terminal of the message is determined as a SSMN terminal.

A virtual number of the SSMN terminal is obtained.

The message is processed by the virtual number.

In another embodiment of the present invention, a SSMN processor, including a number information database module and a query module, is also provided.

The number information database module is adapted to store the relationship between a host number of a SSMN subscriber, a virtual number corresponding to the host number and a virtual number ID corresponding to the virtual number.

The query module is adapted to query the host number and the virtual number ID through the virtual number, or query the virtual number through the host number and the virtual number ID, according to the relationship between the host number, virtual number ID, and virtual number in the number information database module.

In still another embodiment of the present invention, a message service center including a receiving unit and a determination unit is further provided.

The receiving unit is adapted to receive a message.

The determination unit is adapted to determine whether a sending or receiving terminal of the message received by the receiving unit is a SSMN terminal.

Compared with the prior art, the embodiments of the present invention achieve the following advantages.

When sending a message, a SSMN subscriber may select to display different sender numbers directing to various recipients. Meanwhile, when receiving a message from other subscribers, the SSMN subscriber may figure out which virtual number the message is sent to according to the sender number. The message will be processed by the SSMN processor or message service center so as to replace the message sender and recipient, according to the corresponding relationship between the host number, virtual number, and virtual number ID. Therefore, through the embodiments of the present invention, multiple cell-phone numbers, instead of merely the currently used cell-phone number, can be online at the same time.

### BRIEF DESCRIPTION OF THE DRAWINGS

FIG. 1 is a schematic flow chart of a second embodiment of a message processing method, according to the present invention;

FIG. 2 is a schematic flow chart of a third embodiment of a message processing method, according to the present invention;

FIG. 3 is a schematic flow chart of a fourth embodiment of a message processing method, according to the present invention;

FIG. 4 is a schematic flow chart of a fifth embodiment of a message processing method, according to the present invention;

FIG. 5 is a schematic flow chart of a sixth embodiment of a message processing method, according to the present invention;

FIG. 6 is a schematic flow chart of a seventh embodiment of a message processing method, according to the present invention;

FIG. 7 is a schematic structural view of a first embodiment of an SSMN processor, according to the present invention;

FIG. 8 is a schematic structural view of a second embodiment of an SSMN processor, according to the present invention;

FIG. 9 is a schematic structural view of a third embodiment of an SSMN processor, according to the present invention;

FIG. 10 is a schematic structural view of a first embodiment of a message service center, according to the present invention;

FIG. 11 is a schematic structural view of a second embodiment of a message service center, according to the present invention; and

FIG. 12 is a schematic structural view of a third embodiment of a message service center, according to the present invention.

### DETAILED DESCRIPTION

In order to make the objectives, technical solutions, and advantages of the present invention comprehensible, embodiments accompanying with figures are described in detail below.

Assume that a SSMN terminal A owns a host number No.A0, for example, 16*********, and nine virtual numbers No.A1-No.A9 corresponding to the host number No.A0. The nine virtual numbers are respectively corresponding to virtual number IDs 99001-99009 of the host number. The SSMN terminal refers to a terminal adopted by a SSMN subscriber. A SSMN processor stores and maintains the corresponding relationship between the host number, virtual number and virtual number ID, as shown in Table 1. Seen from Table 1, the host number, multiple virtual numbers, and multiple virtual number IDs of the SSMN subscriber are correlated. That is, the host number of each SSMN subscriber is corresponding to multiple virtual numbers. The virtual number ID may be a prefix or a suffix of the virtual number, and the circumstance of a prefix is taken as an example for illustration below. Furthermore, the message may be a multimedia message (MM) or a short message (SM), and the circumstance of a MM is taken as an example for illustration below. When the SSMN terminal A sends a message to a receiving terminal B by a virtual number No.A2 (assume the number of B is 18*********), a recipient field of the input message is the prefix of the virtual number No.A2 plus the number of the receiving terminal B, i.e., 9900218*********. The message after being processed by the SSMN processor is transmitted to the receiving terminal and the sender number displayed on the receiving terminal is the virtual number No.A2. Therefore, the SSMN terminal A is able to communicate with the receiving terminal B through the virtual number No.A2. When the sending terminal B sends a message to the SSMN terminal A, and assumes that the sending terminal B stores the virtual number No.A2 of the SSMN terminal A, a recipient field of the input message from the sending terminal B is the virtual number No.A2 of the SSMN terminal. After being identified by a message service center where the number of the sending terminal B is registered and processed by a message service center where the virtual number No.A2 is registered or processed by the SSMN processor (the detailed implementation process may refer to the following embodiment), the sender number displayed on the SSMN terminal A is in the form of the prefix of the virtual number No.A2 plus the number A of the sending terminal B. Therefore, the SSMN terminal A may figure out which virtual number the sending terminal B is communicated with according to the prefix of the virtual number No.A2, so that multiple numbers can be online at the same time.

TABLE 1
Corresponding relationship between a host number and
multiple virtual numbers of a SSMN terminal

| Host Number | Virtual Number | Virtual Number Prefix |
|---|---|---|
| No. A0 | No. A1 | 99001 |
| | No. A2 | 99002 |
| | No. A3 | 99003 |
| | No. A4 | 99004 |
| | No. A5 | 99005 |
| | No. A6 | 99006 |
| | No. A7 | 99007 |
| | No. A8 | 99008 |
| | No. A9 | 99009 |

In a first embodiment of the present invention, a message handling method is provided. The method includes the following steps.

In Step 101, a message is received from a sending terminal.

In Step 102, the sending or receiving terminal of the message is determined as a SSMN terminal.

The determination may be performed by a SSMN processor. The SSMN processor stores the relationship between a host number, a virtual number and a virtual number ID of the SSMN terminal, and determines that a sending or receiving terminal of the message is a SSMN terminal, according to a sender or recipient field in the message. If the recipient field is a combined number of a virtual number ID and a number of the receiving terminal, the sending terminal of the message is determined as the SSMN terminal. If the SSMN device determines that the recipient field is a virtual number, the receiving terminal of the message is determined as the SSMN terminal. A rule can be preset for determination, for example, determining whether the number of digits in the recipient field matches the preset number, or determining according to particular symbols. The above determination may also be performed by a message service center.

If the sending or receiving terminal of the message is a SSMN terminal, Step 103 is performed. If neither the sending terminal nor the receiving terminal of the message is a SSMN terminal, the received message is processed, according to the prior art.

In Step 103, a virtual number of the SSMN terminal is obtained.

When the SSMN processor determines that the sending terminal of the message is a SSMN terminal, a virtual number of the sending terminal is obtained according to the relationship between a host number, a virtual number and a virtual number ID of the sending terminal. When the above determination is performed by a message service center, a query message may be sent to the SSMN processor to obtain the virtual number of the sending terminal.

When the SSMN processor determines that the receiving terminal of the message is a SSMN terminal, a virtual number of the receiving terminal is obtained according to the recipient field in the message. When the above determination is performed by a message service center, a virtual number of the receiving terminal is also obtained according to the recipient field in the message.

In Step 104, the received message is processed by the obtained virtual number.

When determining that the sending terminal of the message is a SSMN terminal, the SSMN processor replaces the sender field in the message with the virtual number of the sending terminal, replaces the recipient field with the number of the receiving terminal, and sends the message to a message service center where the virtual number of the sending terminal is registered or to a message service center where the number of the receiving terminal is registered.

When determining that the receiving terminal of the message is a SSMN terminal, the SSMN processor determines a virtual number ID and a host number corresponding to the virtual number of the receiving terminal according to the relationship between the host number, virtual number, and virtual number ID of the receiving terminal, replaces the sender field in the message with the virtual number ID plus a number of the sending terminal, replaces the recipient field in the message with the host number of the receiving terminal, and sends the message to a message service center where the host number of the receiving terminal is registered.

When determining that the sending terminal of the message is a SSMN terminal, the message service center adds a field in the message for carrying the virtual number of the sending terminal, replaces the recipient field in the message with the number of the receiving terminal while maintaining the sender field in the message as the host number of the sending terminal, and sends the message to a message service center where the number of the receiving terminal is registered.

When determining that the receiving terminal of the message is a SSMN terminal, the message service center sends a query message to obtain the host number and virtual number ID of the SSMN terminal, adds a field in the message for carrying the virtual number ID with the number of the sending terminal, replaces the recipient field in the message with the host number of the receiving terminal, replaces the sending field in the message with the virtual number of the receiving terminal, and sends the message to a message service center where the host number of the receiving terminal is registered.

The message service center may be a multimedia message service center (MMSC) or a short message service center (SMSC).

The message mentioned in the first embodiment may be a SM or a MM, and the circumstance of a MM is taken as an example below for illustrating the message processing of the present invention.

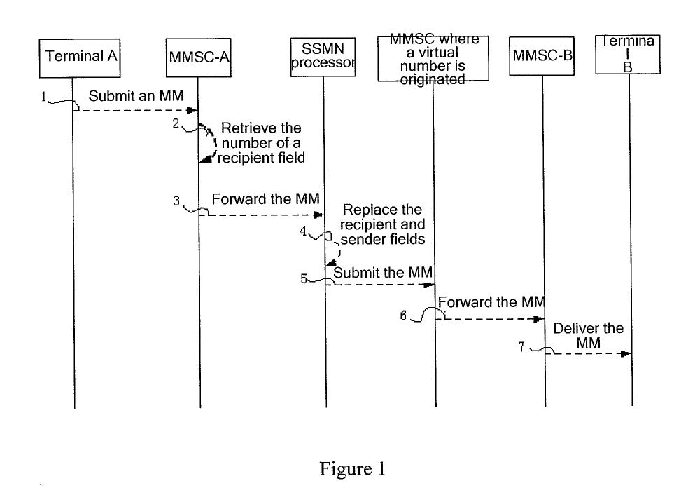

FIG. 1 is a schematic flow chart of a second embodiment of a message processing method, according to the present invention. In the second embodiment, a MM is sent by a virtual number. Referring to FIG. 1, the method includes the following steps.

In Step 1, a sender, i.e., a SSMN terminal A, submits a MM to a multimedia message service center where a host number of A is registered (referred to as MMSC-A for short below).

In the MM, a recipient field is a virtual number ID plus a number of a receiving terminal B (assume the number of B is 18*********). The virtual number ID may be a prefix or a suffix of the virtual number, and the circumstance of a prefix is taken as an example for illustration below. For example, if the virtual number prefix is 99002, the recipient field in the MM is the virtual number prefix 99002 plus the number of the receiving terminal B, i.e. 9900218*********.

In Step 2, the MMSC-A retrieves a number of the recipient field from the received MM.

In Step 3, the MMSC-A sends the MM to a SSMN processor through a MM7 interface. The MM7 interface is an interface for sending/receiving MMs between a service provider (SP) and a MMSC.

In Step 4, the SSMN processor splits the virtual number prefix 99002 from the number of the recipient 18*********, obtains a virtual number of the SSMN terminal A corresponding to the virtual number prefix 99002 from an internal number information database, replaces a sender field of the MM with the virtual number, and replaces the number in the recipient field with the number of the receiving terminal B.

In Step 5, the SSMN processor submits the MM to a MMSC where the virtual number of the SSMN terminal A (i.e., the virtual number corresponding to 99002) is registered. This step is equivalent to the SSMN processor simulating the SSMN terminal A to send the MM.

In Step 6, the MMSC where the virtual number of the SSMN terminal A is registered forwards the MM to a MMSC where the number of the receiving terminal B is registered (referred to as MMSC-B for short below).

In Step 7, the MMSC-B delivers the MM to the receiving terminal B.

In the second embodiment, the subscriber sends a MM by any virtual number and replaces the sender and recipient fields of the MM through the SSMN processor. Therefore, the sender number displayed on the receiving terminal B is the virtual number of the SSMN terminal A.

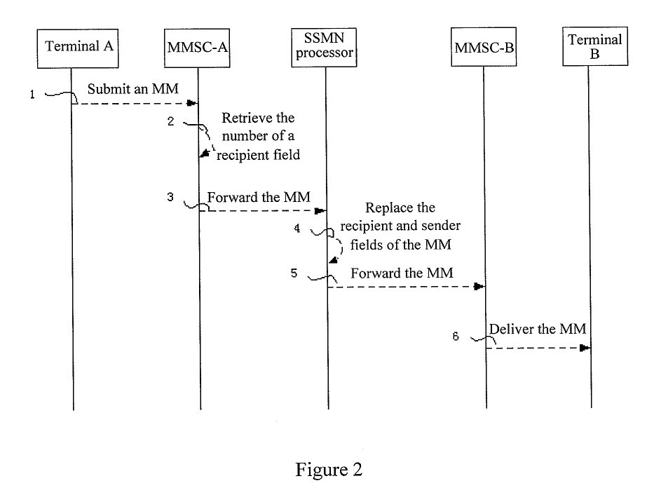

FIG. 2 is a schematic flow chart of a third embodiment of a message processing method, according to the present invention. This embodiment involves another process of sending a MM by a virtual number. Referring to FIG. 2, in this embodiment, Steps 1, 2, 3, and 4 are respectively identical to Steps 1, 2, 3, and 4 in the second embodiment, and the details are not described herein again. Different from the second embodiment, in this embodiment, the SSMN processor may directly access a MMSC where the number of the receiving terminal B is registered (i.e. MMSC-B) through the MM7 interface, i.e., to directly communicate with the MMSC-B. Thus, there is no need to send the MM to the MMSC where the virtual number is registered, and forward the MM to the MMSC-B through the MMSC where the virtual number is registered. Compared with the second embodiment, in this embodiment, the SSMN processor does not need to simulate the terminal of the virtual number to send the MM to the receiving terminal, so that the requirement on the configuration of the SSMN processor is lower. Furthermore, the differences between this embodiment and the second one are described as follows.

In Step 5, the SSMN processor sends the MM to the MMSC-B where the number of the receiving terminal B is registered.

In Step 6, the MMSC-B delivers the MM to the receiving terminal B.

It should be noted that, no matter the SSMN terminal A sends a MM by which virtual number, the MM is first transmitted to the MMSC-A. That is, the host number of the subscriber A remains online, and merely the number of the sender field is replaced by a certain virtual number of the subscriber A through the processing of the SSMN processor. The beneficial effect of this embodiment is that, each virtual number of the SSMN terminal A is corresponding to a recipient unnecessarily in the same circle as A. For example, the recipients corresponding to one virtual number of the SSMN terminal A may be friends of A, the recipients corresponding to another virtual number may be colleagues of A, and the recipients corresponding to still another virtual number may be relatives of A. Different virtual numbers of the subscriber A are stored in the recipient terminal. Communications over MMs can be made with the subscriber A through those virtual numbers. For instance, the subscriber A is at a place of E, the MMSC where the host number thereof is registered is at E, the MMSC where the virtual number No.A2 thereof is registered is at F, and the subscriber B at F records No.A2 as the contact information of the subscriber A. Therefore, the subscriber A may employ the virtual number No.A2 to send a MM to the subscriber B. In this manner, the subscriber A is able to send MMs to any recipient through a corresponding virtual number.

In the third embodiment of the present invention, the SSMN terminal sends a MM by any virtual number and replaces the sender and recipient fields of the MM through a SSMN processor. Therefore, the sender number displayed on the receiving terminal B is the virtual number of the SSMN terminal A, i.e., the virtual number corresponding to the virtual number ID.

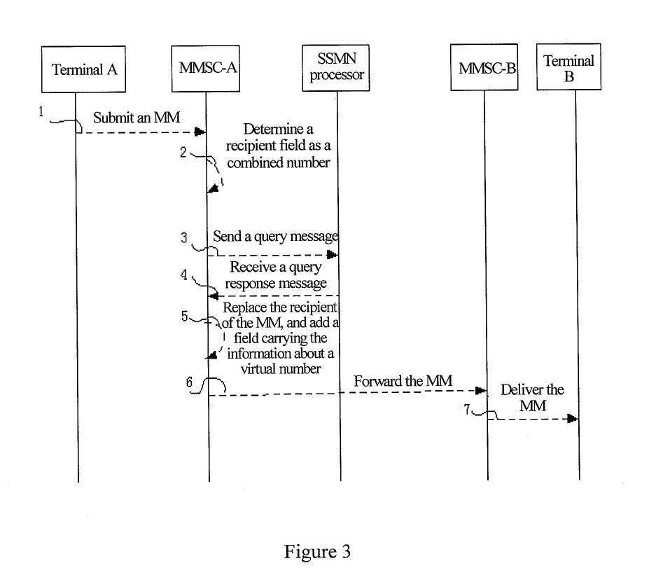

FIG. 3 is a schematic flow chart of a fourth embodiment of a message handling method, according to the present invention. This embodiment involves another process of sending a MM by a virtual number. Referring to FIG. 3, the method mainly includes the following steps.

In Step 1, a MM is submitted to a MMSC where a sender is registered (i.e., MMSC-A).

An SSMN terminal A sends a MM to a receiving terminal B by a virtual number. Assume that the virtual number prefix is 99002 (the prefix of the virtual number corresponding to the virtual number No.A2), and the number of the receiving terminal B is 18*********. A recipient field of the input message from the SSMN terminal A is a combined number of the virtual number prefix 99002 plus the number of the receiving terminal, meaning to send MMs through a particular virtual number.

In Step 2, the MMSC-A determines that the recipient field is a combined number of the virtual number prefix plus the number of the receiving terminal.

In this step, the MMSC-A may determine whether the recipient field is the virtual number prefix plus the number of the receiving terminal by means of a preset rule. The preset rule may be, for example, determining whether the number of digits in the recipient field matches the preset number or determining according to particular symbols.

In Step 3, the MMSC-A sends a query message to the SSMN processor.

TABLE 2
Definition of a query message (MMi_query.REQ)

| Information | Importance of | |
|---|---|---|
| Unit | Presence | Description |
| Version | Essential | Version number, currently adopted as Version 1.0 |
| Message Type | Essential | Message type, valued as “MMi_query.REQ” in this |
| | | message |
| Transaction ID | Essential | ID corresponding to MMi_query.REQ/MMi_query.RES |
| Query Type | Essential | Query type, valued as: |
| | | 1. query a virtual number |
| | | 2. query a host number and a virtual number prefix |
| Host Number | Depending on the | Host number, essential when querying a virtual number |
| | circumstance | |
| Virtual | Depending on the | Virtual number prefix, essential when querying a virtual |
| Number Prefix | circumstance | number |
| Virtual | Depending on the | Virtual number, essential when querying a host number |
| Number | circumstance | |

In this step, the MMSC-A sends a query message to the SSMN processor according to the virtual number prefix 99002 and the host number of the SSMN terminal A in the combined number of the MM recipient field. The query message is configured to query the virtual number (No.A2) corresponding to the virtual number prefix. The format of the query message is shown in Table 2.

In Step 4, the MMSC-A receives a query response message returned by the SSMN processor. The format of the message is shown in Table 3, and the virtual number (No.A2) corresponding to the virtual number prefix is obtained from the query response message.

TABLE 3
Definition of a query response message (MMi_query.RES)

| Information | Importance of | |
|---|---|---|
| Unit | Presence | Description |
| Version | Essential | Version number, currently adopted as Version 1.0 |
| Message Type | Essential | Message type, valued as “MMi_query.RES” in this |
| | | message |
| Transaction ID | Essential | ID corresponding to MMi_query.REQ/MMi_query.RES |
| Status Code | Essential | Response message result, and 0 means successful; |
| | | otherwise, failed. |
| Response Type | Essential | Query response type, valued as: |
| | | 1. query a virtual number |
| | | 2. query a host number and a virtual number prefix |
| Host Number | Depending on the | Host number, returned when the host number is |
| | circumstance | successfully queried |
| Virtual | Depending on the | Virtual number prefix, returned when the host number is |
| Number Prefix | circumstance | successfully queried |
| Virtual | Depending on the | Virtual number, returned when the virtual number is |
| Number | circumstance | successfully queried |

In Step 5, the MMSC-A substitutes the recipient field in the MM.

In this step, the sender field of the MM is maintained as the host number of the SSMN terminal A, a field “Sender Show” for carrying the virtual number of the SSMN terminal A is added in the MM, and the recipient field is replaced by the number of the receiving terminal B.

In Step 6, the MMSC-A forwards the MM to a MMSC where the number of the receiving terminal B is registered (i.e., MMSC-B), and meanwhile replaces the newly added field “Sender Show” with the virtual number No.A2 of the SSMN terminal A, as shown in Table 4.

TABLE 4
Information Unit in MM4_forward.REQ

| | Importance of | |
|---|---|---|
| Information Unit | Presence | Description |
| 3GPP MMS Version | Essential | MMS version of the originator |
| | | MMSRelay/ServerRelay/Server defined in this document |
| Message Type | Essential | Message type “MM4_forward.REQ” on a reference point |
| | | MM4 |
| Transaction ID | Essential | ID corresponding to |
| | | MM4_forward.REQ/MM4_forward.RES |
| *** | *** | *** |
| Sender Show | Optional | If this field exists, this number serves as a sender when |
| | | the recipient MMSC delivers a message to the terminal |

In Step 7, the MMSC-B sets the field “Sender Show” added through a MM4 interface as the sender of the MM, and delivers the MM to the receiving terminal B. Therefore, the sender number displayed on the receiving terminal B is the virtual number No.A2 of the SSMN terminal A. The MM4 interface is a communication interface between the MMSCs.

In this embodiment, the SSMN terminal sends a MM by any virtual number, and replaces the sender and recipient fields of the MM through a SSMN processor. Therefore, the sender number displayed on the receiving terminal B is the virtual number of the SSMN terminal A. Furthermore, since there is no need to forward the MM to the SSMN processor, and only the SSMN processor is required to provide the query message, the working burden of the SSMN processor is alleviated, thus saving the system resources.

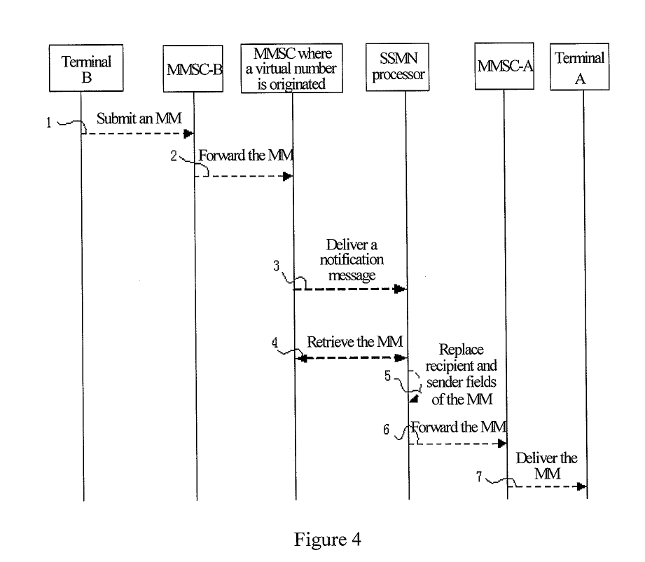

FIG. 4 is a schematic flow chart of a fifth embodiment of a message processing method, according to the present invention. This embodiment involves a process of receiving an MM by a virtual number. The method mainly includes the following steps.

In Step 1, a sending terminal B (assume the number thereof is 18*********) submits a MM sent to a SSMN terminal A to a MMSC where the number of the sending terminal B is registered (i.e., MMSC-B). The recipient field is a virtual number No.A2 of the SSMN terminal A.

In Step 2, the MMSC-B forwards the MM to a MMSC where the virtual number is registered, i.e., the MMSC where the virtual number shown in FIG. 4 is registered.

In Step 3, the MMSC where the virtual number is registered sends a notification message to the SSMN processor, so as to inform the SSMN device to retrieve the MM from the MMSC where the virtual number is registered.

In Step 4, the SSMN processor sends a request message for requesting to retrieve the MM to the MMSC where the virtual number is registered. On receiving the request message from the SSMN processor, the MMSC where the virtual number is registered sends the MM to the SSMN processor.

In Step 5, the sender and recipient fields of the MM are replaced.

The SSMN processor obtains the virtual number prefix 99002 corresponding to the number No.A2 and the host number of the receiving terminal corresponding to the virtual number prefix 99002, i.e., the host number of the SSMN terminal A, by querying an internal number information database thereof, according to the number of the recipient field (No.A2) in the MM. Then, the SSMN processor respectively replaces the sender field of the MM with a combined number (9900218*********) of the prefix (99002) corresponding to No.A2 plus the number of the subscriber B, and replaces the recipient field of the MM with the host number (16*********) of A.

In Step 6, the SSMN processor forwards the MM to the MMSC-A through a MM7 interface.

In Step 7, the MMSC-A delivers the MM to the SSMN terminal A, so that the sender number displayed on the SSMN terminal A is a combined number of the prefix 99002 of the number No.A2 plus the number of the sending terminal B (i.e., 9900218*********).

Therefore, the SSMN terminal A figures out that the sending terminal B sends a MM to the virtual number No.A2 thereof, and is thus able to receive the MM through the virtual number. Since the sending terminal may send a MM to any virtual number of the SSMN terminal, the host number and multiple virtual numbers of the SSMN can be online at the same time.

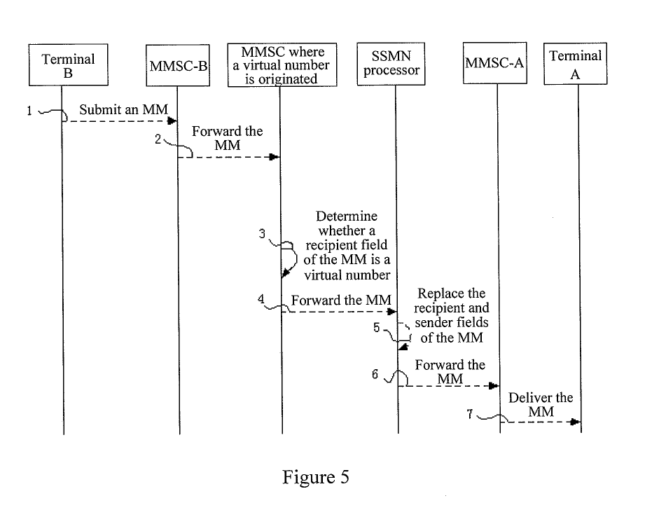

FIG. 5 is a schematic flow chart of a sixth embodiment of a message processing method, according to the present invention. This embodiment involves another process of receiving a MM by a virtual number. Referring to FIG. 5, a sending terminal B sends a MM to a receiving terminal A. The receiving terminal A is a SSMN terminal, and the sending terminal B stores a virtual number of the SSMN terminal A.

The method includes the following steps.

In Step 1, a sending terminal B (assume the number thereof is 18*********) submits an MM sent to a virtual number of a SSMN terminal A to a MMSC where the number of the sending terminal B is registered (i.e., MMSC-B). The recipient field is a virtual number No.A2 of the SSMN terminal A.

In Step 2, the MMSC-B forwards the MM to a MMSC where the virtual number No.A2 of the receiving terminal A is registered, i.e., the MMSC where the virtual number shown in FIG. 5 is registered.

In Step 3, the MMSC where the virtual number is registered determines whether the recipient field in the MM is a virtual number, and if the recipient field in the MM is a virtual number, Step 4 is performed; if the recipient field in the MM is not a virtual number, a normal MM delivery process is performed.

In this step, the MMSC where the virtual number is registered determines whether the recipient field is the virtual number of the SSMN terminal A by means of a preset rule. The preset rule may be, for example, determining whether the number of digits in the recipient field matches the preset number, or determining according to particular symbols.

In Step 4, the MMSC where the virtual number is registered forwards the MM to the SSMN processor.

In Step 5, the SSMN processor replaces the sender and recipient fields of the MM.

In this step, the SSMN processor obtains the virtual number prefix 99002 corresponding to the number No.A2 and the corresponding host number of the SSMN terminal A by querying an internal number information database thereof, according to the number of the recipient field (No.A2) in the MM. Then, the SSMN processor respectively replaces the sender field of the MM with a combined number (9900218*********) of the prefix (99002) corresponding to No.A2 plus the number of the sending terminal B, and replaces the recipient field of the MM with the host number (16*********) of the MMSN terminal A.

In Step 6, the SSMN processor forwards the MM to the MMSC-A through a MM7 interface.

In Step 7, the MMSC-A delivers the MM to the SSMN terminal A, so that the sender number displayed on the SSMN terminal A is a combined number of the prefix 99002 of the number No.A2 plus the number of the sending terminal B (i.e., 9900218*********).

Therefore, the SSMN terminal A figures out that the sending terminal B sends a MM to the virtual number No.A2 thereof.

As such, according to this embodiment, the SSMN terminal is able to receive a MM through a virtual number. Since the sending terminal may send a MM to any virtual number of the SSMN terminal, the host number and multiple virtual numbers of the SSMN can be online at the same time.

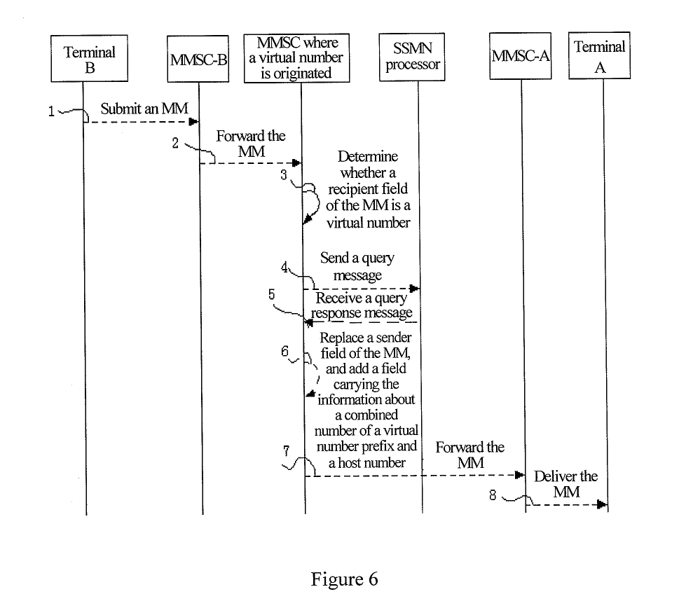

FIG. 6 is a schematic flow chart of a seventh embodiment of a message processing method, according to the present invention. This embodiment involves a process of receiving an MM by a virtual number. The method includes the following steps.

In Step 1, the sending terminal B sends an MM to the virtual number (No.A2) of the SSMN terminal A. Assume that the prefix corresponding to the virtual number is 99002, i.e., the recipient field of the MM is set as the virtual number (No.A2) of the SSMN terminal A. Furthermore, the sending terminal B submits the MM to a MMSC where the number of the sending terminal B is registered (i.e., MMSC-B).

It should be noted that, in this step, the sending terminal B stores the virtual number No.A2 of the SSMN terminal A. The sending terminal B may not necessarily know that No.A2 is a virtual number of the SSMN terminal A, but merely inputs the virtual number into the recipient field.

In Step 2, the MMSC-B forwards the MM to a MMSC, where the virtual number of the SSMN terminal A is registered.

In Step 3, the MMSC where the virtual number is registered determines whether the number of the recipient field in the MM is a virtual number of the SSMN device, and if the number of the recipient field in the MM is a virtual number of the SSMN device, Step 4 is performed; if the number of the recipient field in the MM is not a virtual number of the SSMN device, a normal MM delivery process is performed.

In Step 4, the MMSC where the virtual number is registered sends a query message to the SSMN processor to query the virtual number prefix corresponding to the virtual number and the host number of the receiving terminal, i.e., the host number of the SSMN terminal A.

In Step 5, the MMSC where the virtual number is registered receives a query response message returned by the SSMN processor. The query response message contains the virtual number prefix corresponding to the virtual number and the host number of the SSMN terminal A.

In Step 6, the sender and recipient fields of the MM are replaced.

In this step, the MMSC where the virtual number is registered replaces the sender field of the MM with the virtual number of the SSMN terminal A, adds to the MM a field “Sender Show” with a value of the virtual number prefix plus the number of the sending terminal B (i.e., 9900218*********), and replaces the recipient field of the MM with the host number of the receiving terminal (i.e., the host number 16********* of the SSMN terminal A).

In this step, as the SSMN processor presets a service of actuating a SSMN by a virtual number on the MMSC where the virtual number is registered, the MMSC where the virtual number is registered is enabled to send a query message to the SSMN processor on receiving the MM with the recipient field as the virtual number.

In Step 7, the MMSC where the virtual number is registered sends the MM to a MMSC where the SSMN terminal A is registered, i.e., the MMSC-A where the host number of the SSMN terminal A is registered.

In Step 8, the MMSC-A sets the field “Sender Show” added through a MM4 interface as the sender of the MM, and delivers the MM to the SSMN terminal A. Therefore, the sender number displayed on the SSMN terminal A is the virtual number prefix corresponding to the virtual number plus the subscriber number of the sending terminal B (i.e., 9900218*********). Therefore, the SSMN subscriber A figures out which virtual number the MM is sent to by the sending terminal B.

As such, according to this embodiment, the SSMN terminal is able to receive a MM through a virtual number. Since the sending terminal may send a MM to any virtual number of the SSMN terminal, the host number and multiple virtual numbers of the SSMN can be online at the same time.

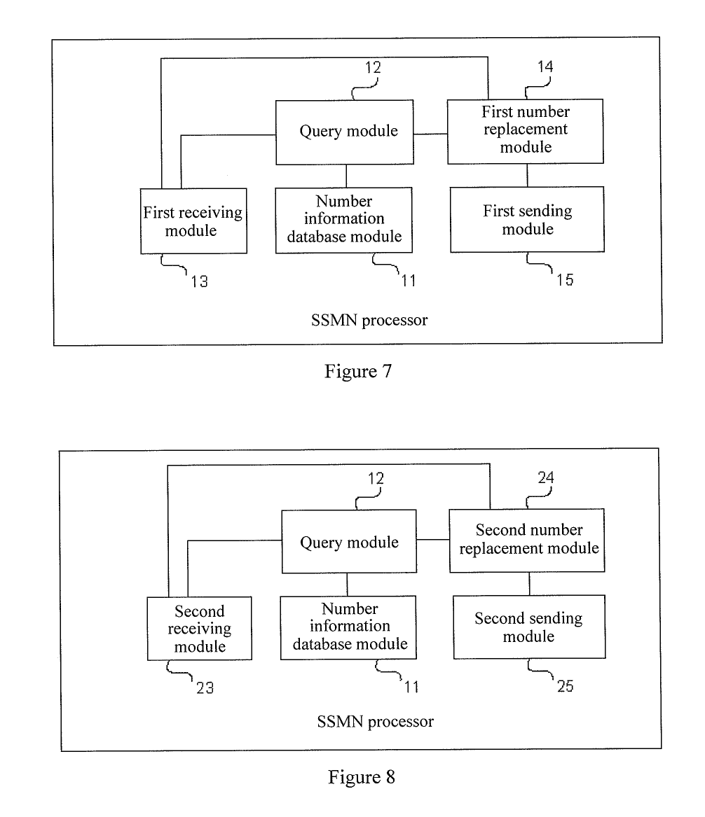

FIG. 7 is a schematic structural view of a first embodiment of a SSMN processor, according to the present invention. The processor includes a number information database module 11 and a query module 12. The number information database module 11 is adapted to store the relationship between a host number of a SSMN subscriber, a virtual number corresponding to the host number and a virtual number ID corresponding to the virtual number. The query module 12 is adapted to query the host number and the virtual number ID through the virtual number, or query the virtual number through the host number and the virtual number ID according to the relationship between the host number, virtual number ID and virtual number in the number information database module 11.

When applied to the process of sending a MM by the sender through a virtual number, the SSMN processor of this embodiment further includes a first receiving module 13, a first number replacement module 14 and a first sending module 15. The first receiving module 13 is connected to the query module 11, the first number replacement module 14 is respectively connected to the query module 11 and the first receiving module 13, and the first sending module 15 is connected to the first number replacement module 14.

When the first receiving module 13 receives the message, the recipient field in the message is a virtual number ID of the sending terminal plus a number of the receiving terminal, and the sender field in the message is a host number of the sending terminal. The query module 12 queries the virtual number corresponding to the virtual number ID through the host number and the virtual number ID, according to the relationship between the host number, virtual number ID, and virtual number in the number information database module 11. The first number replacement module 14 replaces the sender field in the message received by the first receiving module 13 with the virtual number of the sending terminal, and replaces the recipient field in the message received by the first receiving module 13 with the number of the receiving terminal, according to the virtual number of the sending terminal obtained by the query module 12. After that, the message after the replacement is sent to the first sending module 15, and further forwarded by the first sending module 15 to a message service center where the virtual number obtained by the query module 12 is registered or a message service center where the number of the receiving terminal is registered.

FIG. 8 is a schematic structural view of a second embodiment of a SSMN processor, according to the present invention. Here, the processor is applied to the process of sending a message to a virtual number of the receiving terminal. In addition to the number information database 11 and the query module 12 in FIG. 7, the processor further includes a second receiving module 23, a second number replacement module 24, and a second sending module 25. The second receiving module 23 is connected to the query module 12, the second number replacement module 24 is respectively connected to the query module 12 and the second receiving module 23, and the second sending module 25 is connected to the second number replacement module 24. The second receiving module 23 receives the message with the recipient field being the virtual number. The query module 12 queries the host number and the virtual number ID through the virtual number according to the relationship between the host number, virtual number ID, and virtual number in the number information database module 11. The second number replacement module 24 replaces a sender field in the message received by the second receiving module 23 with a virtual number ID of the receiving terminal plus a number of the sending terminal of the message, and replaces a recipient field in the message with a host number of the receiving terminal according to the virtual number ID and host number of the receiving terminal obtained by the query module 12. After that, the message after replacement is sent to the second sending module 25, and further forwarded by the second sending module 25 to a message service center where the host number of the receiving terminal is registered.

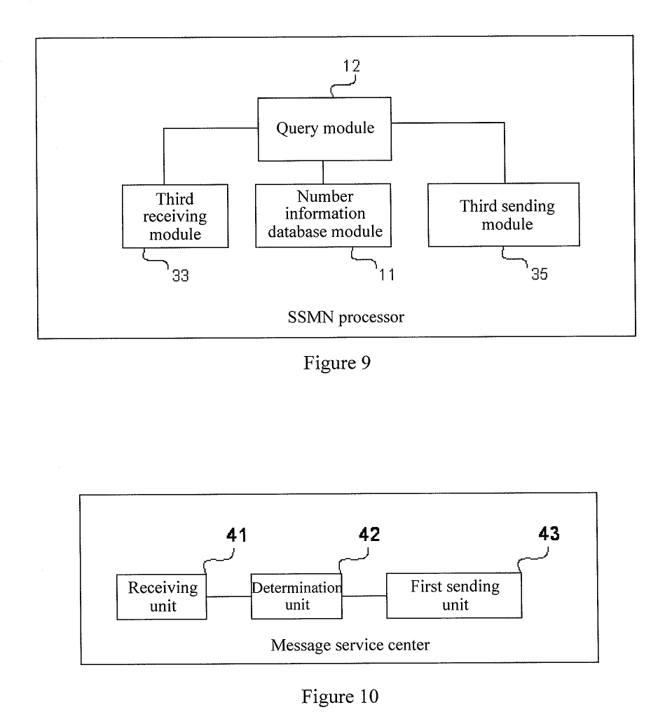

FIG. 9 is a schematic structural view of a third embodiment of a SSMN processor, according to the present invention. This embodiment is applied to assist a sender or recipient message service center to query the corresponding relationship between a host number, a virtual number and a virtual number prefix. In addition to the two modules, i.e., the number information database module 11 and the query module 12 in FIG. 7, the SSMN processor in FIG. 9 further includes a third receiving module 33 and a third sending module 35. The third receiving module 33 is connected to the query module 12, and the third sending module 35 is connected to the query module 12. The third receiving module 33 receives a query request from the message service center, and sends the query request to the query module 12. The query module 12 queries the host number and the virtual number ID through the virtual number, or queries the virtual number through the host number and the virtual number ID, according to the relationship between the host number, virtual number ID, and virtual number in the number information database module 11. Then, the third sending module 35 sends the host number and virtual number ID obtained by the query module 12 to the message service center, or sends the virtual number obtained by the query module 12 to the message service center.

The aforementioned message may be a MM or a SM, and accordingly the message service center may be a MMSC or a SMSC. In the above embodiments, a SSMN subscriber may select one host number and multiple virtual numbers. The SIM card actually used is corresponding to the host number of the subscriber, and the virtual numbers are also real cell-phone numbers. When sending a message, the SSMN subscriber may select to display different sender numbers directing to various recipients. Meanwhile, when receiving a message from other subscribers, the SSMN subscriber may figure out which virtual number the message is sent to according to the sender number. In this manner, multiple cell-phone numbers can be online at the same time, and the subscriber is free to choose any number to receive or send messages. Thus, the present invention is more convenient and flexible.

FIG. 10 is a schematic structural view of a first embodiment of a message service center, according to the present invention. The message service center includes a receiving unit 41 and a determination unit 42. After the receiving unit 41 receives a message, the determination unit 42 determines whether a sending or receiving terminal of the message received by the receiving unit is a SSMN terminal. If it is determined that the sending or receiving terminal of the message is a SSMN terminal, the message service center further includes a first sending unit 43, which is connected to the determination unit 42 and adapted to send the message determined by the determination unit 42 to the SSMN processor for further processing.

If the determination unit 42 determines that the sending terminal of the message is a SSMN terminal, a recipient field of the message received by the receiving unit 41 is a virtual number ID of the sending terminal and a number of the receiving terminal, and a sender field of the message is a host number of the sending terminal, the message service center may have a structure as shown in FIG. 11. FIG. 11 is a schematic structural view of a second embodiment of a message service center, according to the present invention. In addition to the receiving unit 41 and the determination unit 42 in FIG. 101, the message service center further includes a first query unit 54, a first replacement unit 55, and a second sending unit 56. The first query unit 54 is respectively connected to the receiving unit 41 and the determination unit 42, the first replacement unit 55 is respectively connected to the first query unit 54 and the receiving unit 41, and the second sending unit 56 is connected to the first replacement unit 55. When the determination unit 42 determines that the sending terminal of the message received by the receiving unit 41 is a SSMN terminal, the first query unit 54 sends a query request to a SSMN processor for querying the virtual number of the sending terminal according to the relationship between the host number, the virtual number corresponding to the host number, and the virtual number ID of the sending terminal of the message. After the first query unit 54 obtains the virtual number of the sending terminal, according to the virtual number, the first replacement unit 55 maintains the sender field in the message received by the receiving unit 41 as the host number of the sending terminal, adds a field in the message for carrying the virtual number of the sending terminal, and replaces the recipient field in the message with the number of the receiving terminal. Thereafter, the second sending unit 56 sends the message processed by the first replacement unit 55 to a message service center where the receiving terminal is registered.

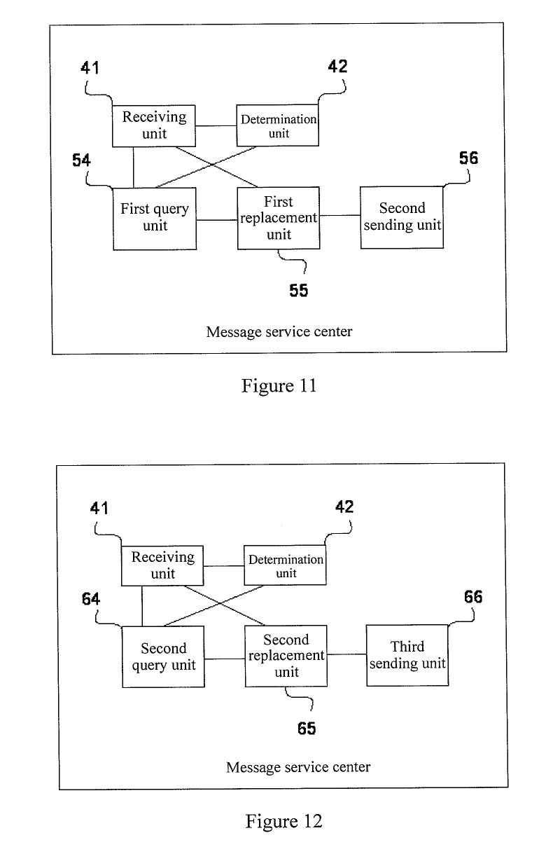

If the determination unit 42 determines that the receiving terminal of the message is a SSMN terminal, the recipient field in the message received by the receiving unit 41 is a virtual number of the receiving terminal, the MMSC may also have a structure as shown in FIG. 12. FIG. 12 is a schematic structural view of a message service center according to a third embodiment of the present invention. In addition to the receiving unit 41 and the determination unit 42 in FIG. 10, the MMSC further includes a second query unit 64, a second replacement unit 65, and a third sending unit 66. The second query unit 64 is respectively connected to the receiving unit 41 and the determination unit 42, the second replacement unit 65 is respectively connected to the second query unit 64 and the receiving unit 41, the third sending unit 66 is connected to the second replacement unit 65. When the determination unit 42 determines that the receiving terminal of the message received by the receiving unit 41 is a SSMN terminal, the second query unit 64 sends a query request to a SSMN processor for querying the host number and the virtual number ID of the receiving terminal, according to the relationship between the host number, the virtual number corresponding to the host number, and the virtual number ID of the receiving terminal of the message. After the second query unit 64 obtains the host number and the virtual number ID of the receiving terminal, according to the host number and the virtual number ID, the second replacement unit 65 replaces the sender field in the message received by the receiving unit 41 with the virtual number of the receiving terminal, replaces the recipient field in the message with the host number of the receiving terminal, and adds a field in the message for carrying the virtual number ID of the receiving terminal and the number of the sending terminal. Thereafter, the third sending unit 66 sends the message after the replacement to a message service center where the host number of the receiving terminal is registered.

In view of the above, according to the embodiments of the present invention, a SSMN subscriber may select one host number and multiple virtual numbers. The SIM card actually used is corresponding to the host number of the subscriber, and the virtual numbers are also real cell-phone numbers. When sending a message, the SSMN subscriber may select to display different sender numbers directing to various recipients. Meanwhile, when receiving a message from other subscribers, the SSMN subscriber may figure out which virtual number the message is sent to, according to the sender number. In this manner, multiple cell-phone numbers can be online at the same time, and the subscriber is free to choose any number to receive or send messages. Thus, the present invention is more convenient and flexible.

Though illustration and description of the present disclosure have been given by reference to exemplary embodiments thereof, it should be appreciated by persons of ordinary skills in the art that various changes in forms and details can be made without deviation from the spirit and scope of this disclosure, which are defined by the appended claims.

What is claimed is:

1. A message processing method, comprising:
receiving a message;
determining a sending or receiving terminal of the message as a single subscriber identity model multiple numbers (SSMN) terminal;
obtaining a virtual number of the SSMN terminal; and
processing the message by using the virtual number.

2. The message processing method according to claim 1, wherein:
when a recipient field in the message is a virtual number ID of the sending terminal and a number of the receiving terminal and a sender field is a host number of the sending terminal, the sending terminal of the message is determined as the SSMN terminal;
obtaining a virtual number of the SSMN terminal comprises: obtaining a virtual number of the sending terminal according to the relationship between the host number, virtual number and virtual number ID of the sending terminal; and
processing the message by using the virtual number comprises: replacing the sender field in the message with the virtual number of the sending terminal, replacing the recipient field with the number of the receiving terminal, and sending the message to a message service center where the virtual number of the sending terminal is registered or to a message service center where the number of the receiving terminal is registered.

3. The message processing method according to claim 1, wherein:
when a recipient field in the message is a virtual number ID of the sending terminal and a number of the receiving terminal, and a sender field is a host number of the sending terminal, the sending terminal of the message is determined as the SSMN terminal;
obtaining a virtual number of the SSMN terminal comprises: sending a query message to a SSMN processor to obtain a virtual number of the sending terminal; and
processing the message by using the virtual number comprises: adding a field in the message for carrying the virtual number of the sending terminal, replacing the recipient field in the message with the number of the receiving terminal, maintaining the sender field in the message as the host number of the sending terminal and sending the message to a message service center where the number of the receiving terminal is registered.

4. The message processing method according to claim 1, wherein:
when the recipient field in the message is a virtual number of the receiving terminal, the receiving terminal of the message is determined as the SSMN terminal;
obtaining a virtual number of the SSMN terminal comprises: obtaining a virtual number of the receiving terminal according to the recipient field in the message; and
processing the message by using the virtual number comprises: according to the relationship between the host number, virtual number, and virtual number ID of the receiving terminal, determining a virtual number ID and a host number corresponding to the virtual number of the receiving terminal, replacing the sender field in the message with the virtual number ID plus a number of the sending terminal, replacing the recipient field in the message with the host number of the receiving terminal and sending the message to a message service center where the host number of the receiving terminal is registered.

5. The message processing method according to claim 1, wherein:
when the recipient field in the message is a virtual number of the receiving terminal, the receiving terminal of the message is determined as the SSMN terminal;
obtaining a virtual number of the SSMN terminal comprises: sending a query message to a SSMN processor to obtain a virtual number ID and a host number of the receiving terminal; and
processing the message by using the virtual number comprises: replacing the sender field in the message with the virtual number of the receiving terminal, adding a field in the message for carrying the virtual number ID of the receiving terminal and a number of the sending terminal, replacing the recipient field in the message with the host number of the receiving terminal and sending the message to a message service center where the host number of the receiving terminal is registered.

6. A single SIM multiple numbers (SSMN) processor, comprising:
a number information database module, adapted to store a relationship between a host number of a SSMN subscriber, a virtual number corresponding to the host number and a virtual number ID corresponding to the virtual number; and
a query module, adapted to query the host number and the virtual number ID through the virtual number, or query the virtual number through the host number and the virtual number ID according to the relationship between the host number, virtual number ID and virtual number in the number information database module.

7. The processor according to claim 6, further comprising:
a first receiving module, adapted to receive a message, wherein a recipient field in the message is a virtual number ID of a sending terminal plus a number of a receiving terminal;
a first number replacement module, adapted to replace a sender field in the message received by the first receiving module with a virtual number of the sending terminal, and replace the recipient field in the message received by the first receiving module with a number of the receiving terminal according to the virtual number of the sending terminal obtained by the query module; and
a first sending module, adapted to send the message processed by the first number replacement module to a message service center where the virtual number or the number of the receiving terminal is registered.

8. The processor according to claim 6, further comprising:
a second receiving module, adapted to receive a message, wherein a recipient field in the message is a virtual number of the receiving terminal;
a second number replacement module, adapted to replace a sender field in the message received by the second receiving module with a virtual number ID of the receiving terminal plus a number of the sending terminal of the message, and replace the recipient field in the message received by the second receiving module with a host number of the receiving terminal according to the virtual number ID and host number of the receiving terminal obtained by the query module; and
a second sending module, adapted to send the message processed by the second number replacement module to a message service center where the host number of the receiving terminal is registered.

9. The processor according to claim 6, further comprising:
a third receiving module, adapted to receive a query request from the message service center, and send the query request to the query module; and
a third sending module, adapted to send the host number and virtual number ID obtained by the query module to the message service center, or to send the virtual number obtained by the query module to the message service center.

10. A message service center, comprising:
a receiving unit, adapted to receive a message; and
a determination unit, adapted to determine whether a sending or receiving terminal of the message received by the receiving unit is a single subscriber identity model multiple numbers (SSMN) terminal.

11. The message service center according to claim 10, wherein:
when the determination unit determines that the sending or receiving terminal of the message is a SSMN terminal, the message service center further comprises:
a first sending unit, adapted to send the message determined by the determination unit to an SSMN processor for further processing.

12. The message service center according to claim 10, wherein:
when the determination unit determines that the sending terminal of the message is a SSMN terminal, a recipient field of the message is a virtual number ID of the sending terminal and a number of the receiving terminal and a sender field of the message is a host number of the sending terminal;
the message service center further comprises:
a first query unit, adapted to send a query request to the SSMN processor to query a virtual number of the sending terminal according to a relationship between the host number, the virtual number corresponding to the host number and the virtual number ID of the sending terminal;
a first replacement unit, adapted to maintain the sender field in the message received by the receiving unit as the host number of the sending terminal, add a field in the message for carrying the virtual number of the sending terminal, and replace the recipient field in the message with the number of the receiving terminal, according to the virtual number of the sending terminal obtained by the first query unit; and
a second sending unit, adapted to send the message processed by the first replacement unit to a message service center where the receiving terminal is registered.

13. The message service center according to claim 10, wherein:
when the determination unit determines that the receiving terminal of the message is a SSMN terminal, the recipient field in the message is a virtual number of the receiving terminal;
the message service center further comprises:
a second query unit, adapted to send a query request to the SSMN processor to query a host number and a virtual number ID of the receiving terminal according to the relationship between the host number, the virtual number corresponding to the host number and the virtual number ID of the receiving terminal;
a second replacement unit, adapted to, according to the host number and the virtual number ID of the receiving terminal obtained by the second query unit, replace the sender field in the message received by the receiving unit with the virtual number of the receiving terminal, add a field in the message for carrying the virtual number ID of the receiving terminal and a number of the sending terminal, and replace the recipient field in the message as the host number of the receiving terminal; and
a third sending unit, adapted to send the message processed by the second replacement unit to a message service center where the host number of the receiving terminal is registered.
